(19) United States
(12) Patent Application Publication
(10) Pub. No.: US 2011/0186594 A1
(43) Pub. Date: Aug. 4, 2011

(54) Hand Sanitizer/Soap Dispenser with high resolution microscope to display, track, and eliminate the presence of live bacterial and viral strands

(76) Inventor: Andre Parker, Miami, FL (US)

(21) Appl. No.: 12/628,050

(22) Filed: Feb. 3, 2010

(51) Int. Cl. B65D 5/66; B67D 7/14

(52) U.S. Cl. 222/52; 222/113

(57) ABSTRACT

The soap dispenser with high resolution microscope displays, tracks, and eliminates the presence of bacteria and viruses. The bacteria and viruses revealed by the invention may be utilized to maintain or improve sanitary conditions in a specific environment in a timely manner. The bacterial and viral strands are identified such that specific colors correspond to specific bacterial/viral strands and are displayed on a LCD monitor located on the front of the dispenser. The invention has two dispensers, one where the bacterial/viral testing solution is stored, and the other where the antibacterial/antiviral hand soap is stored. The high resolution microscope allows a vivid depiction of the live bacteria/viral strands present on user's hands to be displayed on the LCD monitor.

### CROSS-REFERENCE TO RELATED APPLICATIONS

None

### STATEMENT REGARDING FEDERALLY SPONSORED RESEARCH OR DEVELOPMENT

None

### REFERENCE TO SEQUENCE LISTING, A TABLE, OR A COMPUTER PROGRAM LISTING COMPACT DISC APPENDIX

None

### BACKGROUND OF THE INVENTION

1. Field of the Invention

The present invention relates to a stationary device and method for assisting an operator in accurately recording and managing bacterial/viral levels. Specifically, the invention provides a stationary device for effectively exposing and eliminating harmful bacterial/viral germs on people's hands; in addition to tracking the ratio of people who have traces of potentially health threatening bacterial/viral germs.

2. Prior Art

Public establishments typically have a manual soap dispenser mounted to the wall which contains a form of liquid soap. Typically, people do not thoroughly wash their hand nor realize how many health threatening bacteria/viruses they come into contact with on a daily basis.

Even when taking the time to thoroughly cleanse hands but using an ineffective sanitizing solution or soap, problem remain. A person exposes himself or herself to the risk of serious illness. Trips to the doctor, days off of work/school, and the inability to tend to children can create substantial stress for the individual. In some cases, hospitalization may further exacerbate the stress an individual experiences.

Health Agencies have developed various techniques aimed at reducing the spread of bacteria and viruses, such as the proper hand washing technique. While hand washing technique may partially reduce the presence of health threatening viruses/bacteria, the application of this technique alone does not cover the broad area of bacterial/viral germ elimination. Even with the knowledge of the hand washing technique, many tend not to abide by the preferred amount of time one should wash their hands, in addition to not properly massaging soap to eliminate germs. This poses a health risk to the individual because anyone they come into contact with carries a potential to pass or receive new germs that may cause illness.

A more tactical solution to the germ issue is the glo germ product line. U.S. Pat. No. 6,524,390 to Jones, C. Kerry provides a cream, powder, or liquid fluorescent germ detecting agent where the activating agent is an ultraviolet light source. This approach supposedly provides individuals with more effectiveness when detecting the presence of harmful bacterial/viral germs. Like the basic hand washing techniques, fluorescent germ detecting agents partially address the health issue aimed at reducing germ exposure. However, they do not simplify a person's ability to execute this process.

The prior art discloses methods of ameliorating the difficulties of eliminating , bacterial/viral germs and protecting individuals from harmful illnesses. Various efforts have been made to mitigate various viral/bacterial germ sources as well as control their presence in private and public establishments. However, the increasing spread of life threatening illnesses such as H1 N1 has increased the frequency of establishments and institutions being evacuated for quarantining due to unsafe environments. For example, when the invention disclosed in the Jones patent is utilized, an individual is jeopardizing their health by consecutively exposing himself/herself to ultra violet light. Such a system is not a resolution because it presents another health risk, exposure to ultra violet rays, which may lead to epidermal health issues such as skin cancer.

### SUMMARY OF THE INVENTION

The present invention provides a soap/hand sanitizer dispenser that contains a high resolution microscope with an enlarged ocular lens that doubles as a computer, with a screen located on the front of the soap/hand sanitizer dispenser. The purpose is to display, monitor the presence of, and eliminate health threatening bacterial/viral germs present on people's hands. The glass of the objective lens utilizes an ultra violet light (that does not shine on a person's hands or body) to prevent bacteria from accumulating on the objective lens and misrepresenting bacteria or viral germs. In addition, there are two dispensing outlets on the unit; the first is to store a bacterial/viral germ test solution and the second is to store antibacterial/antiviral hand soap. There are two versions of the dispenser (automatic and manual) summarized below.

How It Works (Automatic Dispenser):

Once a person places their hands beneath the hand sanitizer/soap dispenser, the first dispenser automatically dispenses the bacterial/viral test solution onto the persons hands while simultaneously activating the standard microscope light and the ultra violet light on the objective lens glass (to kill any bacteria that may have accumulated on the lens). Next, the high resolution microscope will display the person's positive results for specific hand bacteria/viral germs (if any) on the enlarged ocular lens screen that doubles as a computer, located on the front of the dispenser. After observing the existent or nonexistent bacterial/viral germs, the second dispenser will dispense antibacterial/antiviral soap onto the person's hands while still being displayed on the screen by the objective lens. The antibacterial/antiviral soap will cause existent bacterial/viral germs displayed on the enlarged ocular lens screen to disappear because the germs will no longer test positive with the test solution due to the germs being killed by the soap. Once the person thoroughly massages the soap into their hands, they will see (on the enlarged ocular lens screen/computer) that the bacterial/viral germs have been eliminated and they can now rinse their hands with warm water. The computer verifies the presence of bacterial/viral germs (if any) and records the ratio of people with harmful levels of bacterial/viral germs against those without traces of harmful levels of bacterial/viral germs which assist in preventing an outbreak/epidemic in the atmosphere.

How It Works (Manual Dispenser):

Once a person presses the first pump on the hand sanitizer/soap dispenser, the first dispenser dispenses the bacterial/viral test solution onto the persons hands while simultaneously activating the standard microscope light and the ultra violet light on the objective lens glass (to kill any bacteria that may have accumulated on the lens). Next, the high resolution microscope will display the person's positive results for specific hand bacteria/viral germs (if any) on the enlarged ocular lens in the shape of a screen (the screen is not electronic or a computer on this manual version dispenser), located on the front of the dispenser. After observing the existent or nonexistent bacterial/viral germs, the person presses the second pump on the hand sanitizer/soap dispenser and the second dispenser dispenses antibacterial/antiviral soap onto the person's hands while still being displayed on the screen by the objective lens. The antibacterial/antiviral soap will cause existent bacterial/viral germs displayed on the enlarged ocular lens screen to disappear because the strands will no longer test positive with the test solution due to the germs being killed by the soap. Once the person thoroughly massages the soap into their hands, they will see (on the enlarged ocular lens shaped as a screen) that the bacterial/viral germs have been eliminated and they can now rinse their hands with warm water.

### DESCRIPTION OF THE DRAWINGS

### Manual Version Of The Dispenser:

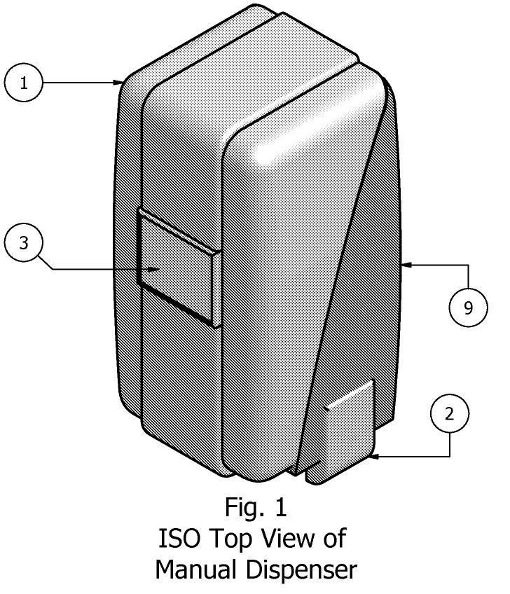

FIG. 1 is a view of the front of the invention.

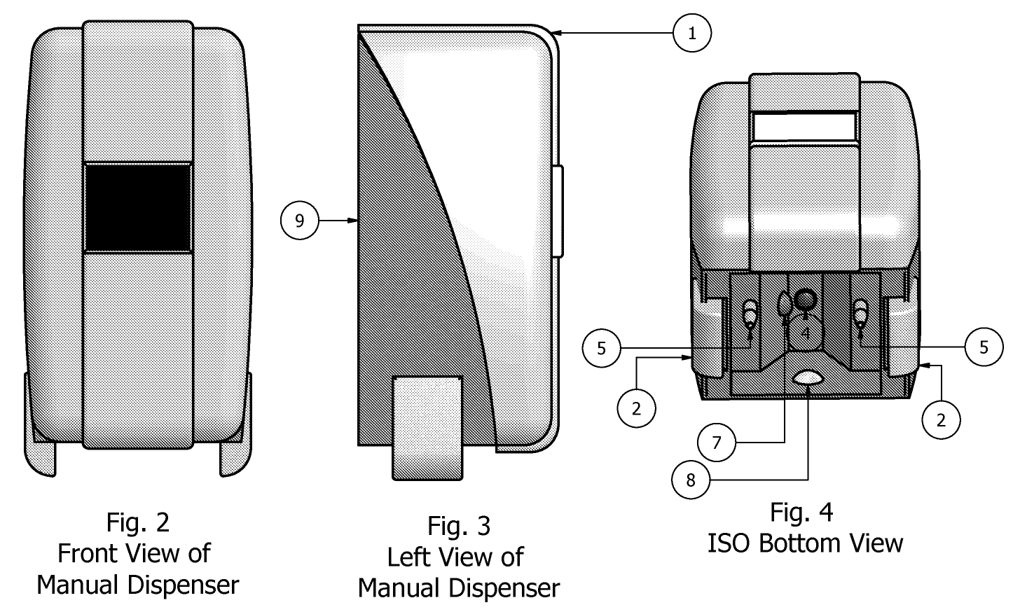

FIG. 2 is a side view of the invention.

FIG. 3 is a view of the opposite side of the invention.

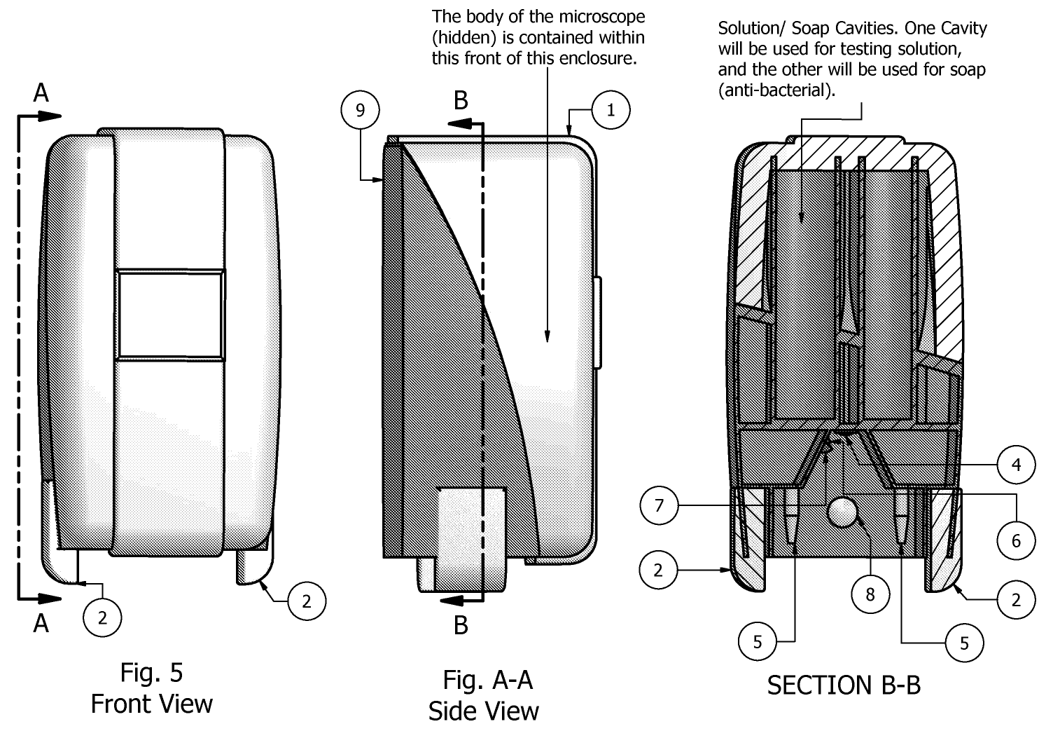

FIG. 4 is a view of the bottom of the invention.

### Automatic Version Of The Dispenser:

FIG. 1 is a view of the front of the invention

FIG. 2 is a view of the bottom of the invention

*Part Specifications are labeled on the professional drawings

What is claimed is:

1. A hand sanitizer dispenser comprising: A main body housing; and a enlarged ocular lens; and a high resolution microscope; and double dispensers; and hand pumps; and infrared lights; and a ultra violet light; and standard light

2. The invention of claim 1 wherein the enlarged ocular lens is a LCD screen that displays images captured by the high resolution microscope.

3. The invention of claim 2 where the enlarged ocular lens is centered on the exterior front surface of the main body housing.

4. The invention of claim 3 further comprising a data storage system to record and calculate ratios of the information received by the high resolution microscope.

5. The invention of claim 4 wherein the data storage system contains a digital video recorder and is a computer with memory.

6. The invention of claim 1 wherein the high resolution microscope contains an objective lens with adjustable magnification capabilities to display bacteria and/or viruses on hands.

7. The invention of claim 6 wherein the objective lens of the high resolution microscope is centered on the bottom exterior surface of the main body housing.

8. The invention of claim 6 further comprising a microscope arm located within the main body housing that connects the objective lens of the microscope to the enlarged ocular lens.

9. The invention of claim 1 wherein the double dispensers are adjacent and hold separate solutions.

10. The invention of claim 9 wherein the double dispensers are located within the main body housing.

11. The invention of claim 1 where there are two hand pumps that release the solutions from the dispensers.

12. The invention of claim 11 where the hand pumps are separately connected to the double dispensers.

13. The invention of claim 12 where the hand pumps are located on the bottom exterior (left and right) of the main body housing.

14. The invention of claim 1 wherein the infrared lights are motion detectors that release solution from the dispensers when triggered.

15. The invention of claim 14 where there are separate infrared lights for each dispenser.

16. The invention of claim 15 where the infrared lights are located on the bottom surface (left and right) of the main body housing.

17. The invention of claim 1 wherein the ultra violet light sanitizes the objective lens of the high resolution microscope.

18. The invention of claim 17 where the ultra violet light is located on the rim of the objective lens, and shines horizontally.

19. The invention of claim 1 wherein the standard light provides clear viewing of objects placed beneath the objective lens of the high resolution microscope.

20. The invention of claim 19 where the standard light is centered on the bottom interior surface of the main body housing so light is evenly distributed.
